(19) United States
(12) Patent Application Publication
(10) Pub. No.: US 2017/0270587 A1
(43) Pub. Date: Sep. 21, 2017

(54) System and Method for Stadium Seating Selection

(71) Applicants: Harris Wolfson, Nicasio, CA (US); Leanne Wolfson, Nicasio, CA (US)

(72) Inventors: Harris Wolfson, Nicasio, CA (US); Leanne Wolfson, Nicasio, CA (US)

(21) Appl. No.: 15/615,252

(22) Filed: Jun. 6, 2017

Related U.S. Application Data
(63) Continuation-in-part of application No. PCT/US17/17882, filed on Feb. 15, 2017.
(60) Provisional application No. 62/295,648, filed on Feb. 16, 2016.

(51) Int. Cl. G06Q 30/06; G06Q 10/02

(52) U.S. Cl. CPC G06Q 30/0629; G06Q 30/0643; G06Q 10/02

(57) ABSTRACT

A system and method for stadium seating selection provides a computer-implemented interactive website and software application that allows a user to determine which stadium seats are in the shade or sun at a given time during an outdoor event and to view a stadium's seating in relationship to the sun and shade according to the date and time of day. The website or app displays a diagram of the stadium of interest with seat or section numbers and shows the orientation of the sun and a progressively moving shade shadow corresponding to the date and time of day. The shade and sun information may also be provided in text or audio format.

### CROSS REFERENCE TO RELATED APPLICATIONS

The present application is a continuation-in-part of PCT International Application No. PCT/US2017/017882, filed Feb. 15, 2017, which claims the benefit of the filing date of U.S. Provisional Patent Application Ser. No. 62/295,648, filed Feb. 16, 2016. The foregoing applications are incorporated by reference in their entirety as if fully set forth herein.

### TECHNICAL FIELD

This written description relates generally to computer networks, websites and software applications (“apps”) for computers, smart phones, and handheld devices, and more particularly to a system and method for stadium seating selection.

### BACKGROUND INFORMATION AND DISCUSSION OF RELATED ART

Hundreds of sports and event stadiums throughout the world have their own website where one can purchase a ticket, as well as learn general information regarding seating locations, parking, concessions, etc. Seats in the shade are preferred by many spectators, particularly on sunny and hot days. Other spectators may prefer a seat that is fully in the sun. However, known sites do not allow the user to determine which seats would be in the shade or sun, and in particular, in the shade or sun on a specific date and time.

Some known online applications can produce a shadow overlay for a given location. Using a maps widget, a user can set the longitude and latitude of the location being searched to see the shadow. The user can then upload an image into the application, and build walls around the image using a drag and stretch mechanism that will create square blocks that the user can then use to set the heights to the appropriate section. Once the user has their blocks built, they can change the GMT time zone to match their location and cycle through the days/times to see the shadow running over their image.

Other applications enable a user to zoom to anywhere in the world and then give an overhead view of that location. Using filtering options, a user can turn the image into a 3D representation of the image. A further function allows the user to cycle through the days and times to see the sun and shade pattern of the location.

The foregoing information reflects the current state of the art of which the present inventor is aware. Reference to, and discussion of, this information is intended to aid in discharging Applicant's acknowledged duty of candor in disclosing information that may be relevant to the examination of claims to the present invention. However, it is respectfully submitted that none of the above information discloses, teaches, suggests, shows, or otherwise renders obvious, either singly or when considered in combination, the invention described and claimed herein.

### SUMMARY

Described below is a system and method for stadium seating selection. Some implementations provide a computer-implemented interactive website and software application that allows a user to determine which stadium seats are in the shade or sun at a given time during an outdoor event, and to view a stadium's seating in relationship to the sun and shade according to the date and time of day. In some implementations, the website or app displays a diagram of the stadium of interest with seat or section numbers and shows the orientation of the sun and a progressively moving shade shadow corresponding to the date and time of day. In some implementations, the shade and sun information may also be provided in text or audio format.

Particular embodiments of the subject matter described in this specification can be implemented so as to realize one or more of the following advantages.

In some implementations, the system provides stadium seating sun or shade information that is useful to the average spectator for reasons of personal preference or comfort.

In some implementations, the system provides stadium seating sun or shade information that is of particular benefit to those that desire to, or must, avoid exposure to the UV light of the sun, e.g., the elderly.

Some spectators may choose a stadium seat by two primary criteria: 1) the subjective choice as to which seat provides the best view of the playing field, and 2) for environmental or climatic conditions sun or shade). A single or static image of stadium shading may not readily transmit this information. In some implementations of the system, the depiction of a moving shadow over time enables a spectator to formulate a decision as to the individual's best seat choice for both field view and climatic conditions at the same time.

Some spectators may prefer a combination of shade and sun during the course of the event. A static image approach will not adequately provide this information without significant effort on the user's part. In some implementations of the system, the depiction of a moving shadow over time informs a spectator of seats that would incur both sun and shade.

In addition, the accuracy of a static model by clicking on seat to determine if it is in the sun/shade, would necessitate 100% accuracy. In some implementations, with the present system's model of a moving shadow over time, the spectator would be less concerned that his/her seat was in the sun/shade at an exact time. As an example, a spectator that thought his/her seat would be in the shade at 3:15 PM and stay that way for the duration of the event, would likely not be as concerned if the shade did not show up until 3:20 PM.

In some implementations, the system provides a quick and efficient method to get an overview of all possible climatic sun/shade conditions in the entire venue.

In some implementations, the system creates a database for forecasting shadows and the sun's location relative to a venue's seating map for any or all outdoor venues. Except for an unforeseen cosmic event, the database will be valid for eons.

In some implementations of the system, once the database of the shadow forecast is created for a specific venue, any schedule of events, for any period of time, can be readily integrated.

In some implementations, the system may depict the difference of the shadow over the venue at different days, weeks, or months throughout the season.

The details of one or more embodiments of the subject matter described in this specification are set forth in the accompanying drawings and the description below. Other features, aspects, and advantages of the subject matter will become apparent from the description, the drawings, and the claims.

Those skilled in the art will appreciate that the conception upon which this disclosure is based readily may be utilized as a basis for the designing of other structures, methods and systems that include one or more of the various features described below.

Certain terminology and derivations thereof may be used in the following description for convenience in reference only, and will not be limiting. For example, words such as “upward,” “downward,” “left,” and “right” would refer to directions in the drawings to which reference is made unless otherwise stated. Similarly, words such as “inward” and “outward” would refer to directions toward and away from, respectively, the geometric center of a device or area and designated parts thereof. References in the singular tense include the plural, and vice versa, unless otherwise noted.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIGS. 1A-1F are a series of views of a stadium seating chart generated by some implementations of the system and method, depicting the orientation of the sun and showing the shadow cast on the seats in the stadium at selected times over the course of the day;

FIG. 2 is a view of a stadium seating chart depicting seating sections that are beneath stadium overhangs that create shade; and

FIG. 3 is a flowchart diagram of one exemplary embodiment for generating stadium shadow information.

### DETAILED DESCRIPTION

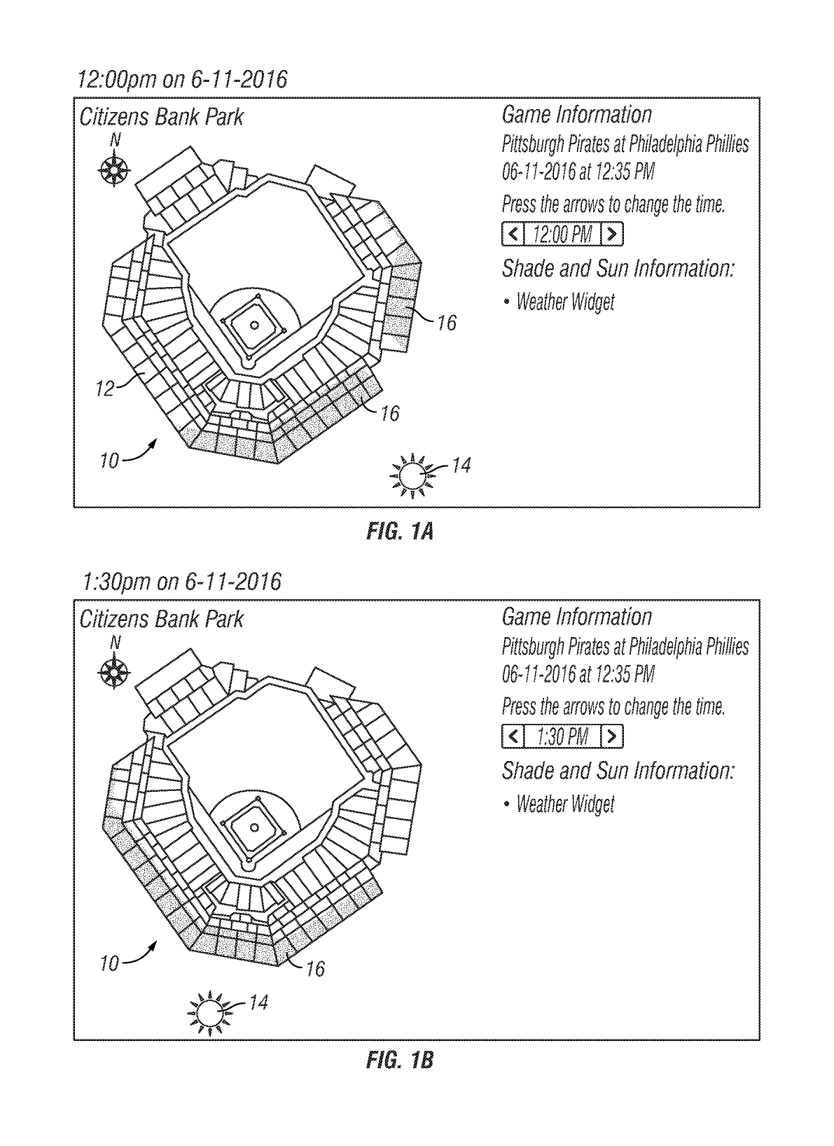

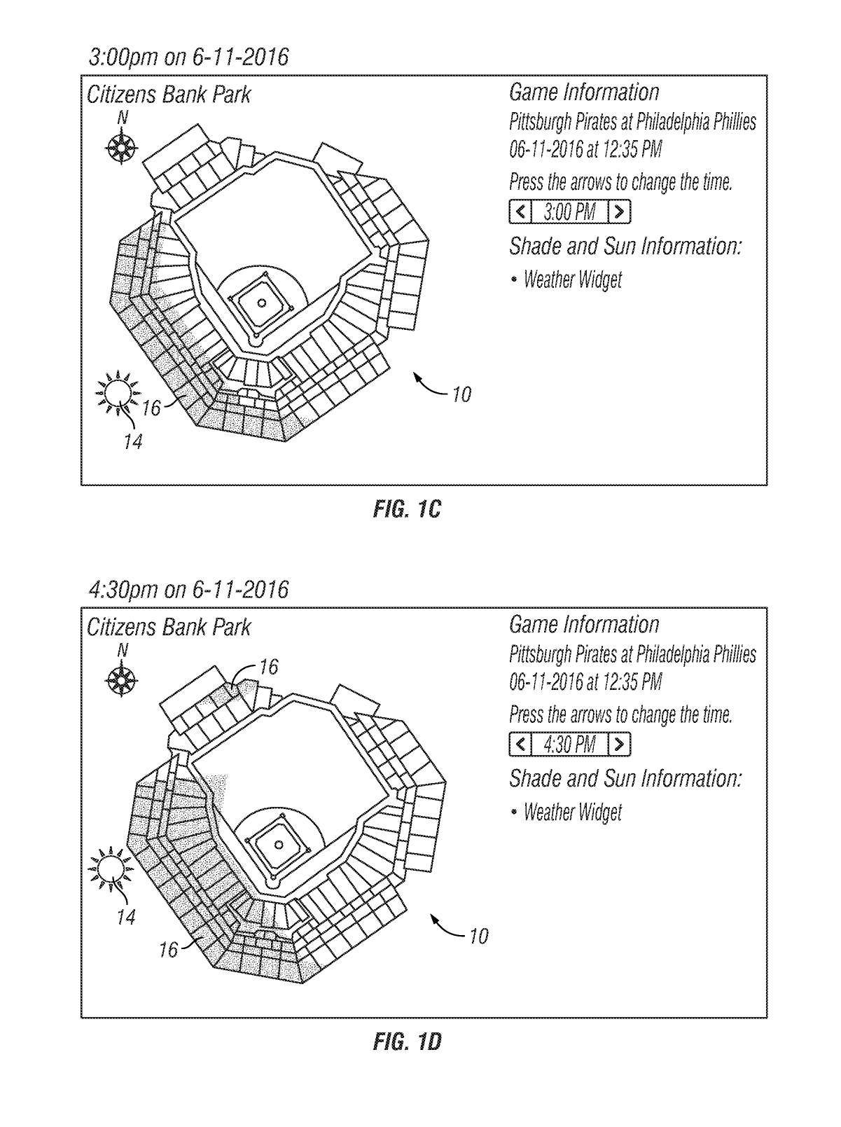

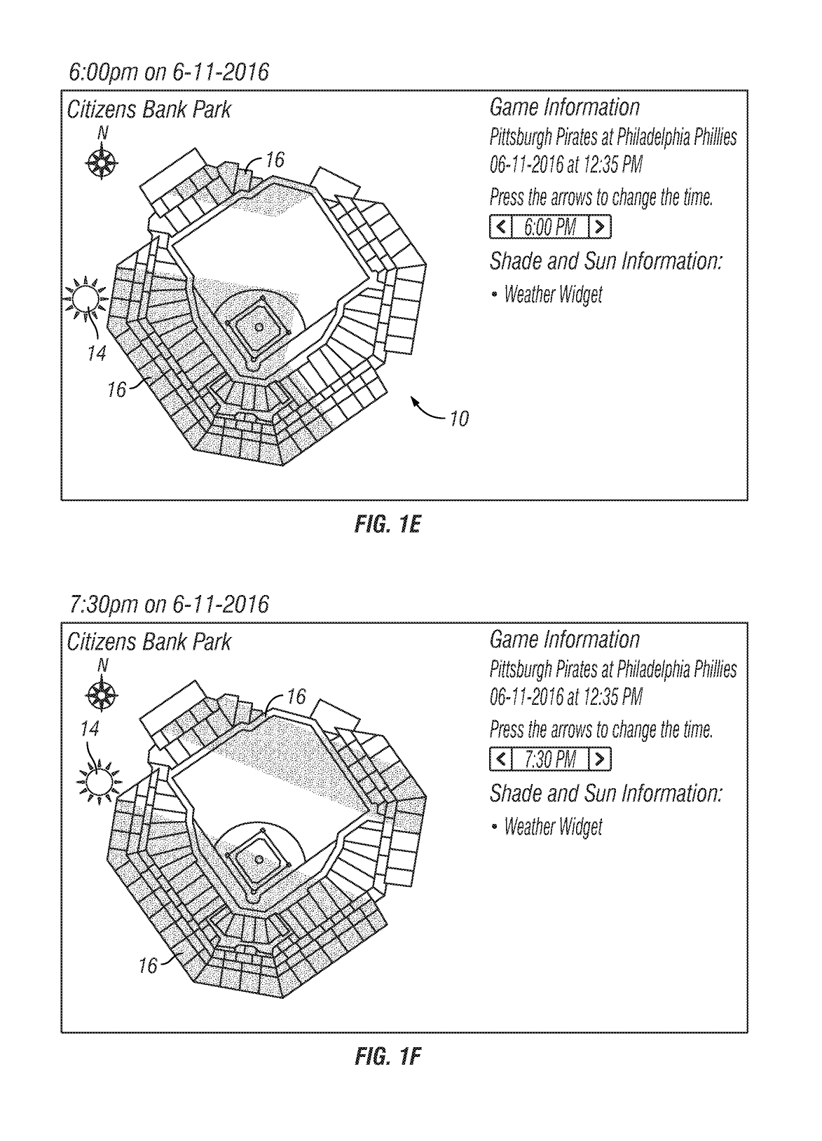

FIGS. 1A-1F are a series of views of a stadium seating chart generated by some implementations of the system and method, depicting the orientation of the sun and showing the shadow cast on the seats in the stadium at selected times over the course of the day.

FIG. 1A shows a map of a stadium 10 and seating sections 12 (rows and seats may also be displayed as scaling permits) at a specific time (here, 12:00 noon) on a specific date (here, 06-11-2016). Sun icon 14 is depicted on the map in its relative orientation to the stadium at this date and time, and shadow image 16 is depicted (as by shading, cross-hatching, or other graphical representation) over those seats/sections that would be in shade at that date and time due to the shadow cast by the stadium and its environs (e.g., stadium walls, signs, scoreboards, etc.).

FIGS. 1B-1F illustrate how the sun and shadow move relative to the stadium over the course of the specified day; FIG. 1B shows the sun icon 14 and shadow image 16 at 1:30 PM, FIG. 1C shows them at 3:00 PM, FIG. 1D shows them at 4:30 PM, FIG. 1E shows them at 6:00 PM, and FIG. 1F shows them at 7:30 PM. A user can readily determine from these images which stadium seats/sections will be in the sun or shade over the course of the event and choose their seats accordingly.

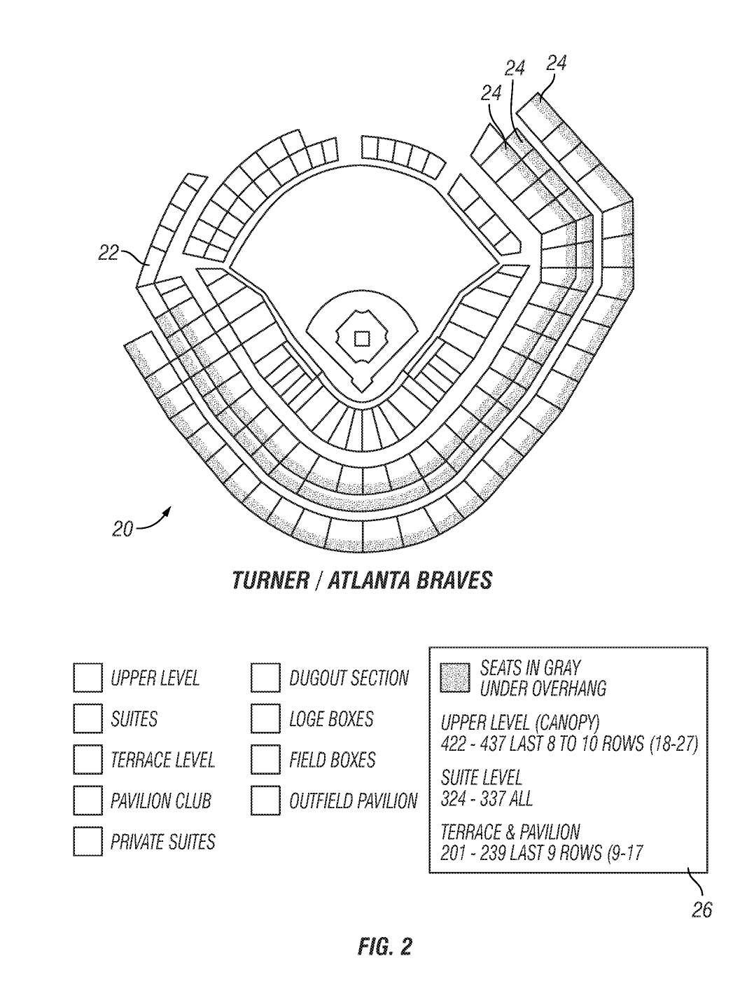

In some implementations, portions of a stadium that are in more or less permanent shade may be depicted. For example, FIG. 2 shows a map of a stadium 20 and seating sections 22, with a static overhang shadow image 24 depicting seating sections that are beneath stadium overhangs that may create more or less permanent shade. Overhang legend 26 may be used to describe those areas in text format.

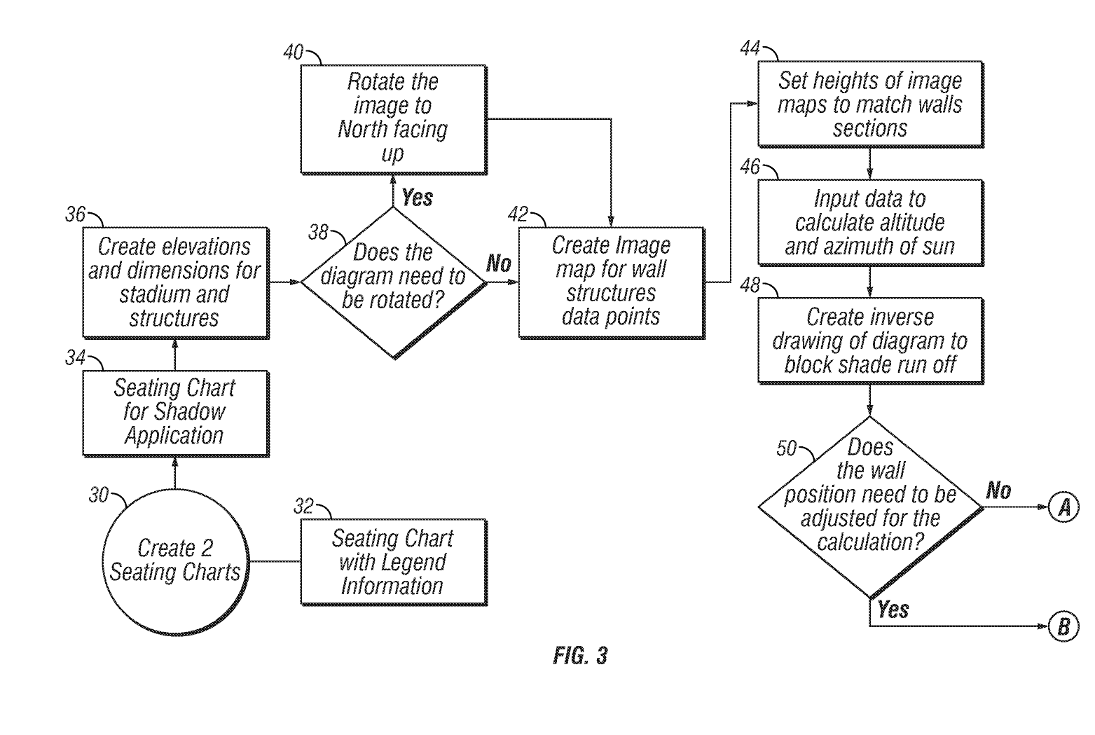

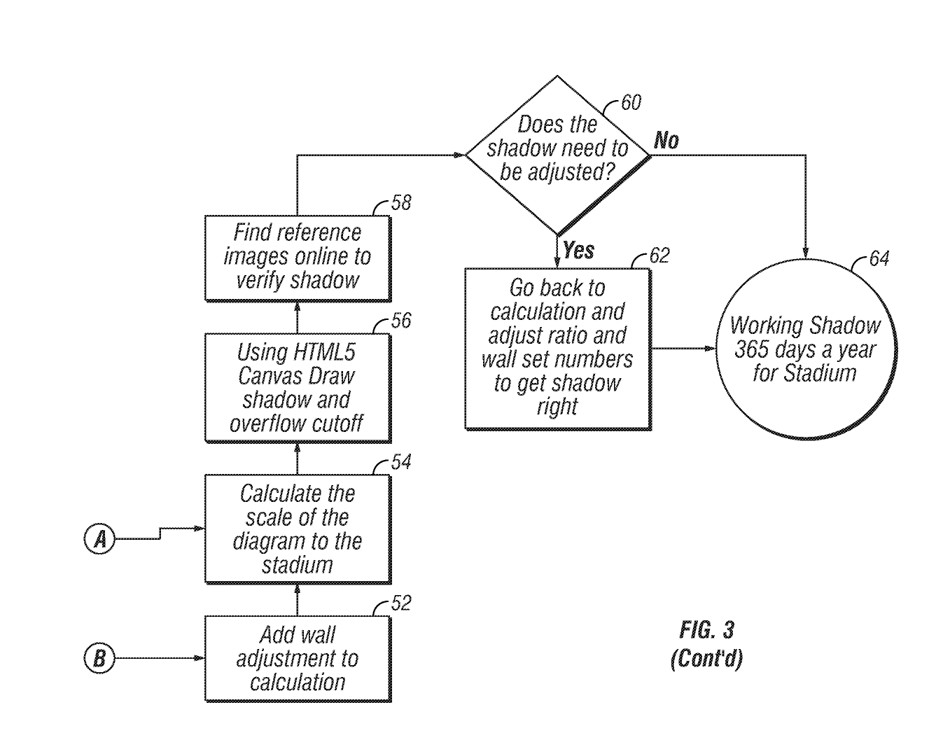

FIG. 3 is a flowchart diagram of one exemplary embodiment for generating stadium shadow information for storage on a computer network device of this disclosure. The process may include some or all of the following steps:

1. Creating two images of a specific outdoor venue's seating chart 30; one seating chart with legend information 32 and one for shadow application 34. The seating chart with the legend information 32 (illustrated in FIG. 2) also depicts (as by gray shading) which seat sections are under overhangs, enabling the user to find seats most likely to have permanent shade (with limitations, e.g., the direction and height of the sun relative to the seats).

2. For the shadow application seating chart 34, gather various elevations and dimensions for outside walls, signs, light towers, etc. and plot the heights and widths on the four sides of the venue (North, East, South, West) at 36.

4. Determining if the seating chart needs to be rotated so that the North Orientation is pointing up at 38, and rotate as necessary at 40.

5. Drawing structures (walls, scoreboards, etc.) on image map generator to obtain coordinates for canvas at 42.

6. Setting heights of individual image maps for each of the sections at 44.

7. Inputting latitude/longitude, time zone, and whether they observe daylight savings or not, which calculates the altitude and azimuth of the sun in relationship to the center of the stadium at 46.

8. Drawing “cut-out” of stadium to prevent shadow run-off at 48.

9. Adjusting walls positions mathematically to calculate the space between the wall and where the seats start at 50 (this is only done when there is a need to push them in or out in relationship to the sections because of the dimensions of the seating diagram being used), and add wall adjustment as necessary at 52.

10. Calculating the approximate scaling of the seating diagram to the actual stadium to determine whether a ratio needs to be set due to the scale of the stadium/image to calculate the appropriate shadow lengths at 54.

11. Using HTML5 canvas, draw the associated shadows and overflow cutoff at 56.

12. Finding reference points using aerial stadium images found online (with accurate meta data) at 58, compare our shadow profiles and the images for accuracy to determine if adjustments are necessary at 60, and then make the proper ratio/wall positions adjustments matching date/time of image at 62.

13. Utilizing the above steps will produce a complete 365 days a year 24 hours a day overlay of the shadow on the seating diagram at 64.

In some implementations, other methods may be used to generate usable shadow movement charts for stadium seating selection of varying detail and accuracy. A basic exemplary embodiment of this disclosure includes some or all of the steps of:

1. Setup image and structures on a shadow finding application (as a reference point);

2. Using an image map generator, create an image map for each ½ hour for the 15th of the month;

3. Utilizing programming languages (such as JavaScript and C#) creating algorithms to turn on/off the correct image maps to depict the shade and sun;

4. Using another online application as a reference manually map the position of the sun in relationship to the stadium center; and

5. Using a pre-built JavaScript, shadow in the image maps being shown per given data.

Another exemplary embodiment of this disclosure includes some or all of the steps of:

1. Drawing structures lines on an image map generator to obtain coordinates for canvas;

2. Setting heights of individual image maps for each for wall sections;

3. Copying/Pasting azimuth and altitude of the sun using the Navy.mil references for the 15th of each month;

4. Using an image overlay, prevent shadow from running off of the image (requires 2 images, 1 of stadium and 1 of “negative space” of stadium);

5. Using HTML5 canvas and C# .net (code sits on server not view able by user), draw the associated shadows; and

6. Automatically calculate the position of the sun in relationship to the stadium center for the sun image by using azimuth.

A further exemplary embodiment of this disclosure includes some or all of the steps of:

1. Inputting latitude/longitude, time zone, and whether they observe daylight savings or not (this calculates the altitude and azimuth of the sun in relationship to the center of the stadium);

2. Drawing “cut-out” of stadium to prevent shadow run-off (trying to use the same numbers as wall pieces to maintain consistent shadowing);

3. Setting heights of individual sections and whether there is a need to push them in or out in relationship to the sections;

4. Determining whether a ratio needs to be set due to the scale of the stadium image;

5. Using HTML5 canvas, draw the associated shadows and overflow cutoff;

6. Finding reference aerial stadium images (with accurate meta data) to compare shadow profiles and make ratio/setback adjustments matching date/time of image; and

7. Generating images for 365 days a year any given time of day instead of just using the 15th of each month (can easily be adjusted to any increment of time lapse to show for ex. 1 min., 15 min., etc.).

This shadow information, however generated, may be stored on a computer network device and provided to a user's computing device (such as a computer, smart phone, tablet, or other network-enabled device) on request, as by connecting to a website for the computer network device. In some implementations, website instructions for the user may include some or all of:

1. From the Home Page, choose either a Sport or Event.

2. Choose a game or event from the schedule. Note: The website is updated automatically with a venue's schedule of events.

3. Once a specific game or event is chosen, the “Shadow Page” will appear with the Shadow Clock set for 1 hour before the game is to start. Note: The Shadow Page depicts the specific venue's seating diagram with Seating Section No.'s.

4. If no game/event is chosen, a user can go to the default venue for the current date and see the seating diagram from sun up to sundown. (Note this is done if no current events are available for a particular venue).

5. Clicking on the Shadow Clock indicator presents the shadow progression across the seating chart (displayed in 30 min increments from sun up to sundown).

6. On the Shadow Page are links that will take the User to the Legend Page and/or a link to a Seating Vendor. Note: The Legend Pages contains a color graphic of the various seating sections (usually labeled by the Venue Franchise). The legend also depicts which seat sections are located under overhangs or under cover (e.g., Suites).

Another exemplary embodiment of the disclosure creates a search function that will allow users to search for venues and/or games from the home page and take them right to the “Shadow Page”. On the “Shadow Page” the user may see more games or events for that venue so the user doesn't have to go back and select a different game or event.

Some embodiments of the program/website of the disclosure may provide one or more of: a diagram of each stadium with section locations and seat numbering; longitude and latitude of each stadium; orientation of each stadium to North; depiction of adjacent high-rise buildings or other potential objects that will block the sun; height of the stadium; or a separate narrative explaining which seats would be out of direct sunlight, and/or in the shade. Other information may also be provided, e.g., the orientation of parking to the stadium seat selections.

The system and method may thus be characterized as a computer-implemented method of illustrating shaded seating in a stadium for an event, including presenting, on a web browser of a client computing device, a graphical display of a stadium for an event specified by the user of the client computing device, the graphical display including a shadow image on the portions of the stadium that are in the sun's shadow at a plurality of times over the course of an event due to the shadow cast by the stadium and its environs.

The system and method may also be characterized as a method, including providing, in a computer network device, information regarding seating in a stadium that is in the sun's shadow at a plurality of times over the course of an event due to the shadow cast by the stadium and its environs, and wherein the information is stored in a memory in the computer network device; receiving, in the computer network device, a request for the information from a user computing device, wherein the user computing device is separate from the computer network device; and delivering the information from the computer network device to the user computing device.

The system and method may also be characterized as a computer-implemented method for outputting graphical visual information identifying shaded and potentially sunny seats in a stadium for an event selected by a user, the method including outputting a graphical display of a stadium map on an electronic display of a user's computing device, the stadium map comprising a plurality of individual seats or sections and graphically depicting a shadow image on those seats or sections that would be in the sun's shade at a plurality of times over the course of an event due to the shadow cast by the stadium and its environs, the stadium map being stored in memory of a network computing device.

Utilization by participants: A further exemplary embodiment of the disclosure is directed to the actual participants (as opposed to spectators) of the game or event, such as sports players. For example, some baseball stadiums have high incidences of dropped fly balls during certain parts of the day because of the way the stadium is oriented, e.g., fly balls can go from dark shadows into bright sun and vice versa. The system may be used to inform players in advance of when and where to hit fly balls to take advantage of this. Thus, the system may be used in formulating strategies in playing a sport.

Written format: A further exemplary embodiment of the disclosure provides a text representation of the shade information generated by the system. For example, businesses that are associated with stadiums (business to business, or B to B relationships), such as ticket sellers, may desire the shadow and sun information for section and seat number in written format. This will allow them to easily display the information on their sites without having to fully integrate the shadow animation the application produces. This can be accomplished utilizing the same techniques as above, but instead of creating a graphical representation, the information can be output in JSON, XML, or other format, or in a custom Application Program Interface (API) to be easily consumed by partners.

For example, business partners could provide a string variable through their website or application formatted such as: (AT&T Park|1/1/2017|section:300|row: a|seat:5). The inventive system would then be able to take those variables as input parameters and return to the business partner a JSON or XML formatted data representation of the shade and sun pattern. Below is an example of a JSON version:

{“stadium”: ATT Park,

“date”: “1/1/207”,

“section”: “300”,

“row”: “a”,

“seat”: “5”,

“sun up”: “6:30 AM”,

“sun down”: “7:30 PM”,

“6:30 am shade”: “yes”,

“7:00 am shade”: “yes”,

“7:30 am shade”: “yes”,

“8:00 am shade”: “no”,

“8:30 am shade”: “no”, etc.

“7:00 pm shade”: “no”,

“7:30 pm shade”: “yes”,

“sun exposure”: “full”,

“weather”: “[“cloudy”, “chance of rain 70%”, “1:00 pm”, “5:00 pm”]”

The business partner could then take the data passed to them and display it on their site however they see fit. An example for one possible solution (this could show up on the side of the website when someone is looking at a certain ticket they wanted to buy): “Seat 5, Row A, Section 300: On 1/1/2017, the seat you selected will have shade on it from 6:30 am to 7:30 am and again at 7:30 pm. There is a high chance of rain between 1:00 pm and 5:00 pm. In normal conditions this seat would have full sun exposure during game hours.”

An example of a text/JSON version for use with seats that are beneath an overhang as discussed supra and depicted in FIG. 2 could read, e.g.: “Section 237, Row 11, Seat G; On 1/1/2017 the seat you selected is under an overhang. The seat will be shaded except for the hours between 2:30 pm and 3:30 pm when the sun will be directly in front of you.”

Voice representation: A further exemplary embodiment of this disclosure, particularly for mobile platforms, provides an AI voice communication (e.g., Siri, Amazon Echo, etc.) to interact with the consumer through speech (i.e., the shade and sun information is provided in audio format). This will allow the consumer to ask a specific question about a stadium, section, and even seat on a given day, and the application would then recognize the question and relay the shadow and sun information they seek via voice.

Weather Integration: A further exemplary embodiment of this disclosure integrates weather information, particularly if the date request is within several days of the event. For example, a user might ask the phone app to provide the sun and shade of AT&T Park on Feb. 1, 2017 at section 301 seat 15, and if the weather calls for clouds, the mobile application could respond that “the normal shade pattern for this day is . . . etc. . . . , but due to current weather conditions it appears the seat you requested will be in the shade all day with possible chance of rain.”

Seat Availability: A further exemplary embodiment of this disclosure provides a search function for business to consumer (B to C), enabling users to look for all or specific sections of seats in the shade or sun for a stadium and event and then find seats which are available for purchase from ticket vendors and the cost of the ticket. The search criteria could include the number of adjoining seats required, wheelchair accessibility, etc. The application would take those variables as input parameters and return a JSON or XML formatted data representation in a text format.

### Example 1

Event: 1/1/2017: AT&T Park Baseball Game between the S.F. Giants and Oakland A's. Request: 4 Adjoining Seats in Shade in selected Section 301. Availability: Ticket Seller A: Section 301, Row 2, Seat No.'s 10,11,12,13; Cost: $120 each.

### Example 2

Event: 1/1/2017: AT&T Park Baseball Game between the S.F. Giants and Oakland A's. Request: 4 Adjoining Seats Available in Shade in selected Section 301. Availability: Section 301 Not Available. Ticket Seller A; Closest Section Available in Shade; Section 308, Row 9, Seat No.'s. 7,8,9,10; Cost: $90 each. Ticket Seller B; Closest Section Available in Shade; Section 310, Row 18, Seat No.'s. 18,19,20,21; Cost: $80 each. Ticket Seller C: Closest Section Available in Shade; Section 400, Row 13, Seat No.'s. 4,5,6,7; Cost: $110 each. Ticket Seller D: Closest Section Available in Shade; Section 501, Row 11, Seat No.'s. 16,17,18,19; Cost: $110 each.

In some implementations, the app or website may also be of use to secondary ticket sellers to be used as a vehicle to buy blocks of tickets that are in the shade and to be resold on their site.

The above disclosure is sufficient to enable one of ordinary skill in the art to practice the invention, and provides the best mode of practicing the invention presently contemplated by the inventor. While there is provided herein a full and complete disclosure of the preferred embodiments of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like.

Therefore, the above description and illustrations should not be construed as limiting the scope of the invention, which is defined by the appended claims.

What is claimed as invention is:

1. A method comprising:
providing, in a computer network device, information regarding seating in a stadium that is in the sun's shadow at a plurality of times over the course of an event due to the shadow cast by the stadium and its environs, and wherein the information is stored in a memory in the computer network device;
receiving, in the computer network device, a request for the information from a user computing device, wherein the user computing device is separate from the computer network device; and
delivering the information from the computer network device to the user computing device.

2. The method of claim 1 wherein the information comprises a diagram of a stadium of interest with seat or section numbers and a progressively moving shade shadow corresponding to the date and time of day.

3. The method of claim 1 wherein the information comprises a diagram of an orientation of the sun relative to a stadium of interest according to the date and time of day of an event.

4. The method of claim 1 wherein the information comprises a diagram of a stadium depicting seating sections that are beneath stadium overhangs that may create permanent shade.

5. The method of claim 1 wherein receiving, in the computer network device, a request for the information from a user computing device, and delivering the information from the computer network device to the user computing device comprises connecting to a website for the computer network device.

6. The method of claim 1 wherein the information is provided to the user computing device in written format.

7. The method of claim 1 wherein the information is provided to the user computing device in audio format.

8. The method of claim 1 wherein the information includes weather information.

9. A computer-implemented method for outputting graphical visual information identifying shaded and potentially sunny seats in a stadium for an event selected by a user, the method comprising:
outputting a graphical display of a stadium map on an electronic display of a user's computing device, the stadium map comprising a plurality of individual seats or sections and graphically depicting a shadow image on those seats or sections that would be in the sun's shade at a plurality of times over the course of an event due to the shadow cast by the stadium and its environs, the stadium map being stored in memory of a network computing device.

10. The method of claim 9 wherein the stadium map comprises a progressively moving shade shadow corresponding to the date and time of day.

11. The method of claim 9 wherein the stadium map comprises a diagram of an orientation of the sun relative to a stadium of interest according to the date and time of day of an event.

12. The method of claim 9 wherein the stadium map depicts seating sections that are beneath stadium overhangs that may create permanent shade.

13. The method of claim 9 wherein outputting a graphical display of a stadium map on an electronic display of a user's computing device comprises connecting to a website for a computer network device.

14. A computer-implemented method of illustrating shaded seating in a stadium for an event, comprising:
presenting, on a web browser of a client computing device, a graphical display of a stadium for an event specified by the user of the client computing device, the graphical display including a shadow image on the portions of the stadium that are in the sun's shadow at a plurality of times over the course of an event due to the shadow cast by the stadium and its environs.

15. The method of claim 14 wherein the graphical display comprises a diagram of a stadium with seat or section numbers and a progressively moving shade shadow corresponding to the date and time of day.

16. The method of claim 14 wherein the graphical display comprises a diagram of an orientation of the sun relative to a stadium of interest according to the date and time of day of an event.

17. The method of claim 14 wherein the graphical display comprises a diagram of a stadium depicting seating sections that are beneath stadium overhangs that may create permanent shade.

18. The method of claim 14 wherein presenting, on a web browser of a client computing device, comprises connecting to a website for a computer network device.
